(19) United States
(12) Patent Application Publication
(10) Pub. No.: US 2017/0017773 A1
(43) Pub. Date: Jan. 19, 2017

(54) SYSTEM AND METHOD FOR MEDICAL CANNABIS DISPENSARY AND DOCTOR DIRECTORY MANAGEMENT AND VERIFICAITON

(71) Applicant: VREZH SARIBEKYAN, LOS ANGELES, CA (US)

(72) Inventor: VREZH SARIBEKYAN, LOS ANGELES, CA (US)

(73) Assignee: BUDZGO, INC., N. HOLLYWOOD, CA (US)

(21) Appl. No.: 14/798,446

(22) Filed: Jul. 13, 2015

(51) Int. Cl. G06F 19/00; H04W 4/02; G06Q 30/06

(52) U.S. Cl. CPC G06F 19/3456; G06Q 30/0639; H04W 4/02

(57) ABSTRACT

A method comprising steps (a) a medical cannabis patient at a geographical location using a computing device registers to access a computer network system; (b) a patient verification process is provided, wherein the patient verification process enables the system to verify a physician issued recommendation for the medical cannabis patient; (c) a first directory list is provided, wherein the first directory list comprises a first list of dispensaries, wherein the first list of dispensaries is located in proximity to the geographical location; (d) the medical cannabis patient selects a dispensary from the first list of dispensaries; and (e) a plurality of information is provided.

### CROSS-REFERENCE TO RELATED APPLICATIONS

N/A

### BACKGROUND OF THE INVENTION

1. Field of the Invention

The present invention is in the technical field of data processing. More particularly, the present invention relates to a system and method for medical cannabis dispensary and doctor directory management and verification.

2. Discussion of the State of the Art

Medical cannabis dispensaries are licensed pharmacies providing safe access to medical cannabis for qualified patients. To access these medical cannabis dispensaries, patients must have a doctor's referral recommending medical cannabis to treat various medical conditions. As further research on cannabis is done, the list of medical conditions treatable by medical cannabis is increasing. Since the source and quality of medical cannabis is not regulated, many patients do not know which dispensary to try without physically driving to each one.

Consequently, there is a need for a system enabling patients to locate cannabis dispensaries and compare the dispensaries based on reviews and menus without the need to physically drive to each dispensary. Further, there is a need for a system enabling patients to locate doctors for consolations and referrals.

The subject matter claimed attempts to solve these disadvantages while providing other useful features that improve a medical cannabis patient's experience. The inventive embodiments described below give patients total control of their expectations, saving time and making their medical cannabis experience more efficient.

### BRIEF SUMMARY OF THE INVENTION

In one embodiment of the present invention, a method is provided comprising steps (a) a user at a geographical location using a mobile device logs in to a mobile computer network system; (b) a first directory list is provided, wherein the first directory list comprises a first list of dispensaries; (c) a second directory list is provided, wherein the second directory list comprises a first list of doctors; (d) the user enters a plurality of search preferences, wherein the plurality of search preferences comprises a distance radius and a selection of search parameters; (e) a third directory list is provided as a result of the plurality of search preferences, wherein the third directory list comprises a second list of dispensaries; and (f) a fourth directory list is provided as a result of the plurality of search preferences, wherein the fourth directory list comprises a second list of doctors.

In one embodiment, the first, second, third, and fourth directory list is provided on a graphical map. Also in one embodiment, a dispensary from the first or second list of dispensaries includes a menu. In one embodiment, the menu comprises a plurality of medical cannabis at various quantities, varieties, and prices.

In another aspect of the invention, a method is provided comprising steps (a) a medical cannabis patient at a geographical location using a computing device registers to access a computer network system; (b) a patient verification process is provided, wherein the patient verification process enables the system to verify a physician issued recommendation for the medical cannabis patient; (c) a first directory list is provided, wherein the first directory list comprises a first list of dispensaries, wherein the first list of dispensaries is located in proximity to the geographical location; (d) the medical cannabis patient selects a dispensary from the first list of dispensaries; and (e) a plurality of information is provided, wherein the plurality of information comprises a dispensary name, an address, a listing of operational hours, a rating score, a distance from the geographical location, a menu, a plurality of photos, a plurality of patient reviews, a plurality of sales promotions, and a plurality of contact information; wherein the menu comprises a plurality of medical cannabis.

In one embodiment, there is a further step wherein the plurality of medical cannabis may be purchased, wherein the purchased medical cannabis is delivered to the medical cannabis patient. In one embodiment, in step (a), the computing device is a mobile phone. Also in one embodiment, in step (b), the patient verification process is performed by a third-party medical cannabis patient verification company. In one embodiment, in step (c), the first directory list is provided on a graphical map.

Yet in another embodiment, there is a further step wherein the medical cannabis patient may upload a plurality of verification data to the system, wherein the plurality of verification data comprises a picture of identification and a picture of the physician issued recommendation, wherein the plurality of verification data is stored on the mobile phone. Also in another embodiment, there is a further step wherein the medical cannabis patient may access a brick and mortar dispensary from the first list of dispensaries by providing the plurality of verification data.

In another aspect of the invention a system is provided comprising an Internet-connected computerized appliance having a processor and coupled to a data repository, the processor executing software from a non-transitory medium, the software providing an interactive interface to a mobile application system, the system enabling a medical cannabis patient to: register an account; log on; verify a physician issued recommendation; set a plurality of search preferences; access a directory list of dispensaries, each dispensary having a menu of cannabis; access an address and operational hours to each dispensary; access a directory list of doctors; access an address, fees, and operational hours to each doctor; save each dispensary to favorites; save cannabis of the menu of cannabis to favorites; access a digital loyalty card to each dispensary; and access an entertainment interface.

In one embodiment, the system further enables the medical cannabis patient to: upload a plurality of verification data to the system, wherein the plurality of verification data comprises a picture of identification and a picture of the physician issued recommendation, wherein the plurality of verification data is stored. Also in one embodiment, the cannabis from the menu of cannabis may be purchased, wherein the purchased cannabis is delivered to the medical cannabis patient. In one embodiment, the entertainment interface comprises an Internet radio station and a gaming station. Yet in another embodiment, the system further enables the medical cannabis patient to: access a brick and mortar dispensary from the first list of dispensaries by providing the plurality of verification data.

### BRIEF DESCRIPTION OF THE SEVERAL VIEWS OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments. Referring to the drawings in which like reference character(s) present corresponding part(s) throughout:

FIG. 1 is an architectural diagram of an Internet mobile computer network system according to an embodiment of the present invention.

FIG. 2 is an architectural diagram of an Internet computer network system according to an embodiment of the present invention.

FIG. 3 is an architectural diagram of an application software network system according to an embodiment of the present invention.

FIG. 4 is a flow diagram illustrating steps a user may take to utilize the mobile application software according to an embodiment of the present invention.

FIG. 5 illustrates a flowchart for a verification process according to an embodiment of the present invention.

FIG. 6 illustrates a flowchart for an application system according to an embodiment of the present invention.

FIG. 7 is a screenshot of a user interface illustrating a registration interface according to an embodiment of the present invention.

FIG. 8 is a screenshot of a user interface illustrating a verification page according to an embodiment of the present invention.

FIGS. 9-16 are screenshots of a user interface illustrating a directory interface according to an embodiment of the present invention.

FIG. 17 is a screenshot of a user interface illustrating a plurality of preferences according to an embodiment of the present invention.

FIG. 18 is a screenshot of a user interface illustrating a marketing reward interface according to an embodiment of the present invention.

FIGS. 19-20 are screenshots of a user interface illustrating an administrative interface according to an embodiment of the present invention.

FIG. 19 illustrates a flowchart for a mobile application according to an embodiment of the present invention.

FIG. 20 illustrates a flowchart for a doctor registration process according to an embodiment of the present invention.

FIG. 21 illustrates a flowchart for an application system according to an embodiment of the present invention.

FIG. 22 illustrates a flowchart for an application system according to an embodiment of the present invention.

### DETAILED DESCRIPTION OF THE INVENTION

In one embodiment of the instant invention, the inventor provides to a system and method for medical cannabis dispensary and doctor directory management and verification enabling a user access to a medical cannabis verification process and dispensary and doctor listings saving time and making their experience more efficient. The system in a preferred embodiment dynamically manages a directory list of dispensaries and doctors while also managing user preferences that enables real time aggregation of search results represented by a directory of dispensary and doctor listings. The system and methods of the invention are described in detail below.

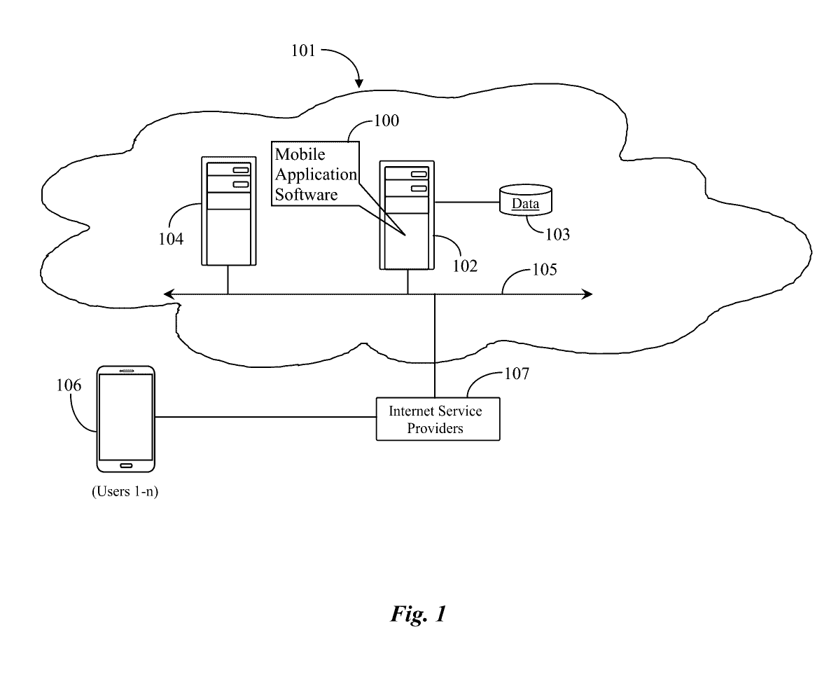

FIG. 1 is an architectural diagram of an Internet 101 mobile computer network system according to an embodiment of the present invention. The Internet-connected system comprises one or more Internet-connected servers 102 executing mobile application software 100 from non-transitory media. Server 102 is connected to a data repository 103, which may be any sort of data storage known in the art. The system further comprises a third party Internet-connected server 104 connected to Internet backbone 105. Although one third party Internet-connected server 104 is shown, it is understood that potentially millions of other similar servers are connected to the Internet via Internet backbone 105. A number of users (1-n) 106 on a mobile device are connected to the Internet-connected server via an Internet service provider (ISP) 107, allowing users 106 to access the mobile application software.

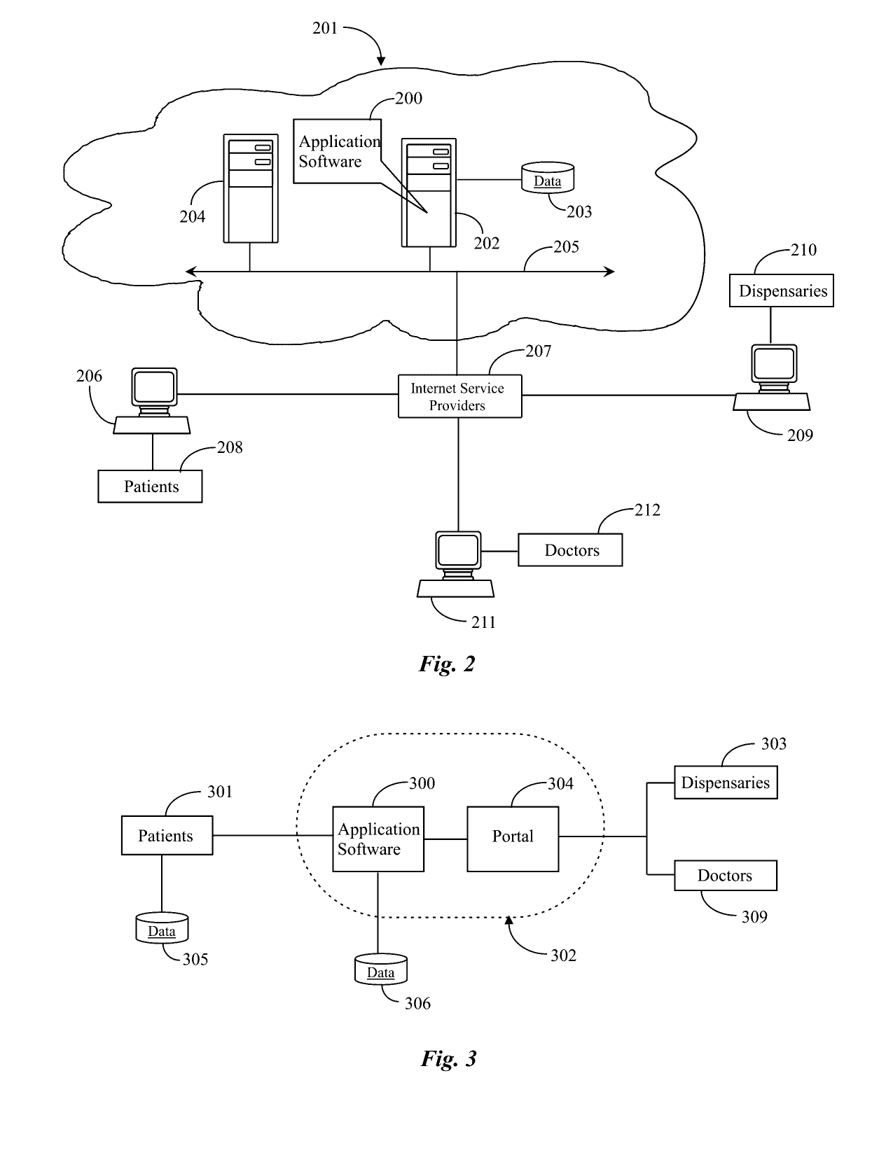

FIG. 2 is an architectural diagram of an Internet computer network system according to an embodiment of the present invention. The Internet-connected system comprises one or more Internet-connected servers 202, executing application software 200 from non-transitory media. Server 202 is connected to a data repository 203, which may be any sort of data storage known in the art. The system further comprises a third party Internet-connected server 204 connected to Internet backbone 2105. Although one third party Internet-connected server 204 is shown, it is understood that potentially millions of other similar servers are connected to the Internet via Internet backbone. A plurality of patients 205 on computing devices 206 are connected to the Internet-connected server via an Internet service provider (ISP) 207, allowing the patients to access the application software. The system further comprises a plurality of dispensaries 210 using computing devices 209 to access the application software via the Internet service provider and Internet backbone. The dispensaries may be any entity offering medical cannabis including but not limited to medical cannabis dispensaries, medical cannabis collectives, and medical cannabis delivery services. In the preferred embodiment, the dispensaries are entities that dispense medical cannabis. However, it shall be understood, depending on state and federal laws recreational cannabis may be included, and the system is not limited to medical cannabis. Yet, the system further comprises a plurality of doctors 212 using computing devices 211 to access the application software via the Internet service provider and Internet backbone. This will be described in greater detail below.

FIG. 3 is an architectural diagram of an application software 300 network system according to an embodiment of the present invention. The system comprises patients 301 in communication with the application software over network 302. Patients 301, represents any number of patients on a computer with local storage data 305. In the preferred embodiment, the computer is a mobile device or tablet computer. The system further comprises dispensaries 303 and doctors 309 in communication with portal 304 and application software 300 over the network. The portal allows the dispensaries and doctors to upload data to the application software which is stored in data source 306. This data can be accessed by the patients over the network.

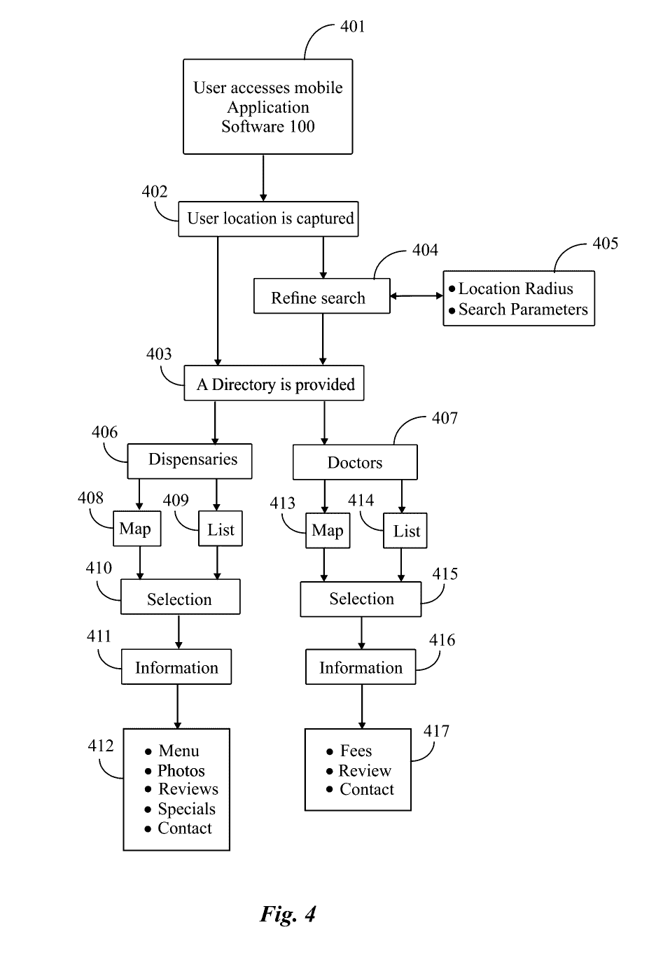

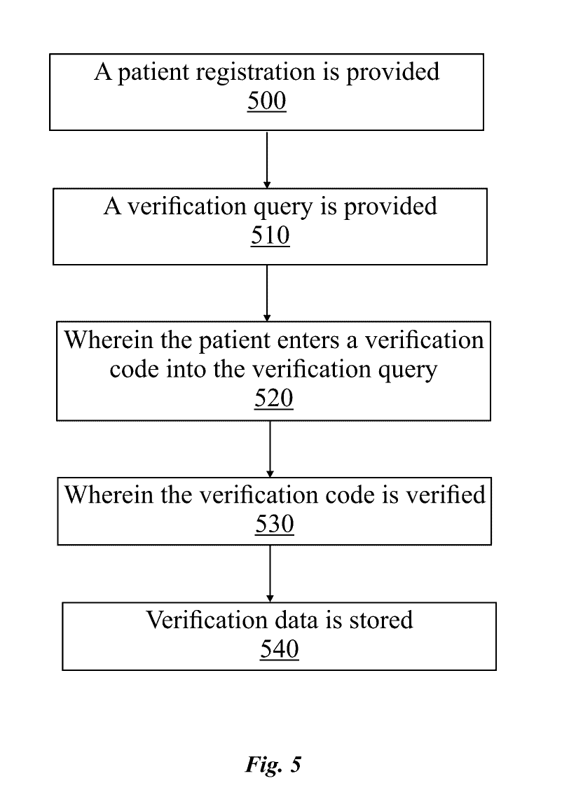

FIG. 4 is a flow diagram illustrating steps a user may take to utilize the mobile application software according to an embodiment of the present invention. In step 401, a user accesses mobile application software 100. In the preferred embodiment, the user accesses the system on a mobile device, such as smartphone or tablet. It shall be understood, that the system can be accessed from a standard computing device, such as a desktop computer. In step 402, the user location is captured, based on the geolocation from where the software is being accessed. This may be from the global positioning system (GPS) located in the mobile device. In step 403, a directory is provided. The directory includes a list of dispensaries 406 and doctors 407. In steps 408-414, the user may select to view the directory list of dispensaries and doctors in either a map or list view. The details of the map and list view will be discussed in greater detail below. The directory provided is based on the user's location in step 402. A predetermined distance radius will limit the directory to only include dispensaries and doctors located within the predetermined distance radius. However, in step 404, a user may refine the search, including location and search parameters 405. For instance, a user may selected a distance radius 10 miles, to limited the directory to only include dispensaries and doctors located within 10 miles of the user's location. In some embodiments, the location radius may be set in 10 mile increments from 10 miles to 50 miles. The search parameters include a plurality of additional search options including but not limited to photos, accessibility, 18+, 21+ specials, system members, payment acceptance type (credit cards/debit cards). For instance, a user may further limit the directory to only include dispensaries and doctors that accept credit cards.

Still referring to FIG. 4, a user may make a selection 410 of a specific dispensary provided in the directory by either map or list view. Next, in step 411, information is provided of the specific dispensary that was selected. This information includes a plurality of options 412, including but not limited to a menu, photos, reviews, specials, and contact. Likewise, a user may make a selection 415 of a specific doctor provided in the directory by either map or list view. Next, in step 416, information is provided of the specific doctor that was selected. This information includes a plurality of options 417, including but not limited to a fees, reviews, and contact. The details of the information and plurality of options will be described in greater detail below.

FIG. 5 illustrates a flowchart for a verification process according to an embodiment of the present invention. In step 500, a patient registration is provided. The patient registration includes typical registration information as well known in the art including but not limited to, name, address, and email address. Next in step 510, a verification query is provided. The verification query comprises an alpha numeric entry box accepting a user's verification code. Specifically, the verification code is a code which represents a patient's current standing as a qualified medical cannabis patient. In step 520, the patient enters the verification code into the verification query. Next, in step 530, the verification code is verified. The verification code is verified by a third party verification service, including but not limited to Medibook or Greenlife. In some embodiments, a patient may choose which verification service is used. Finally, in step 540, the verification is stored.

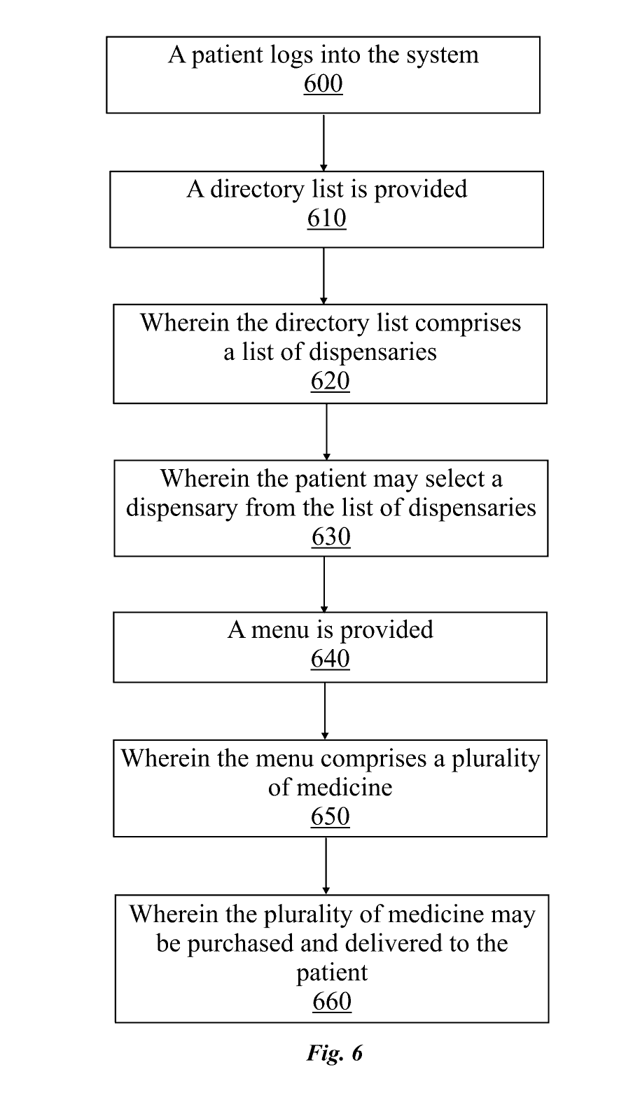

FIG. 6 illustrates a flowchart for an application system according to an embodiment of the present invention. In step 600, a patient logs into the system. In step 610, a directory list is provided. In step 620, the directory list comprises a list of dispensaries. Next, in step 630, the patient may select a dispensary from the list of dispensaries. Once the selection is made, a menu is provided in step 640. In step 650, the menu comprises a plurality of medicine. In the preferred embodiment, the plurality of medicine contains medical cannabis, including but not limited to medical cannabis dried flowers, medical cannabis edibles, and medical cannabis concentrates. Last, in step 660, the plurality of medicine may be purchased and delivered to the patient. In some embodiments, delivery services may not be available. In this exemplary instance, a patient may go to the dispensary directly to purchase the plurality of medicine.

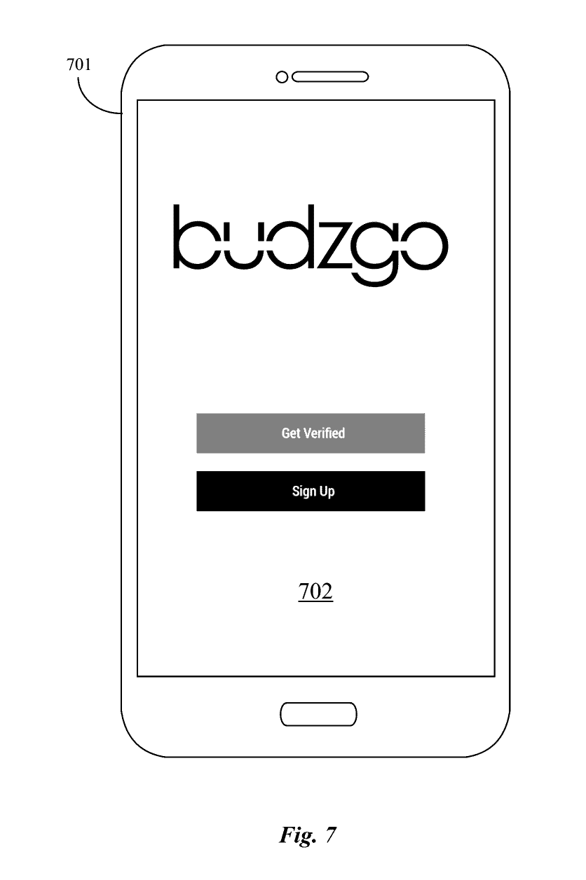

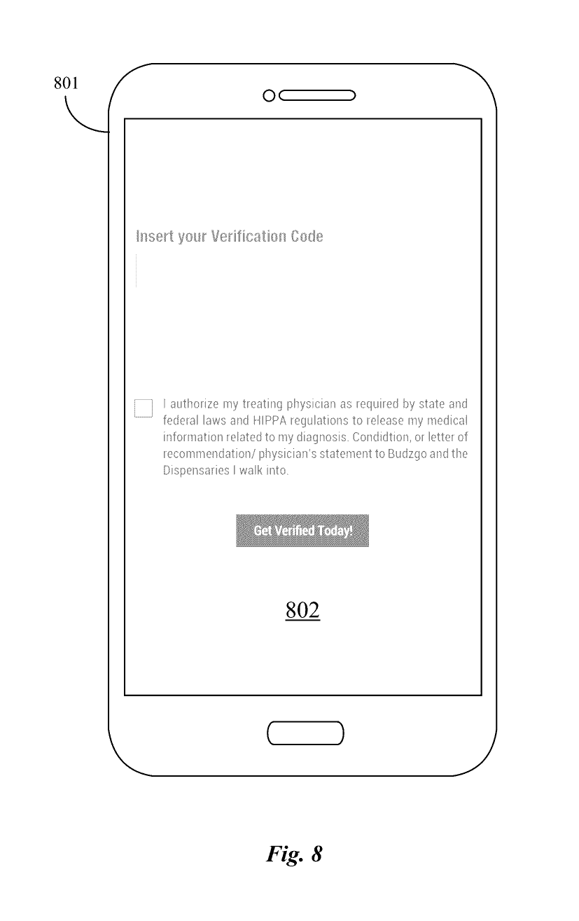

FIG. 7 is a screenshot of a user interface illustrating a registration interface 702 according to an embodiment of the present invention. The user interface is shown on a mobile device 701. The mobile device may be a smartphone running an Android operating system or iOS, an operating system (OS) found on Apple, Inc. products such as an iPhone or iPad. The mobile device comprises a screen for displaying user interfaces, a processor, a storage device, a cellular network antenna for connection with cellular networks by communication with satellites, and Wi-Fi capabilities for connection with local Internet networks as well known in the art. The registration interface allows a user to create an account which enables a user to set preferences and provide user information that is stored locally in the system.

FIG. 8 is a screenshot of a user interface illustrating a verification page 802 according to an embodiment of the present invention. In the exemplary embodiment, a verification query is provided. The verification query comprises an alpha numeric entry box accepting a user's verification code. Specifically, the verification code is a code which represents a users' current standing as a qualified medical cannabis patient. Once the user enters the verification code into the verification query, and agrees to the terms and conditions, the verification code is verified. The verification code is verified by a third party verification service, including but not limited to Medibook or Greenlife. In some embodiments, a patient may choose which verification service is used. After successful verification, a user may use the system and mobile application when visiting a dispensary. When visiting a medical cannabis dispensary, it is required for a patient to have verification documents before the patient is allowed to enter the dispensary and purchase medicine. The verification documents include identification (ID) and a medical cannabis script or referral/recommendation. The verification process described above, allows a patient to upload these verification documents to their mobile device, which conveniently allows the patient to enter and purchase medicine without having to carry the physical verification documents. Furthermore, the verification process is required to have medicine delivered to the patient, as illustrated in FIG. 6.

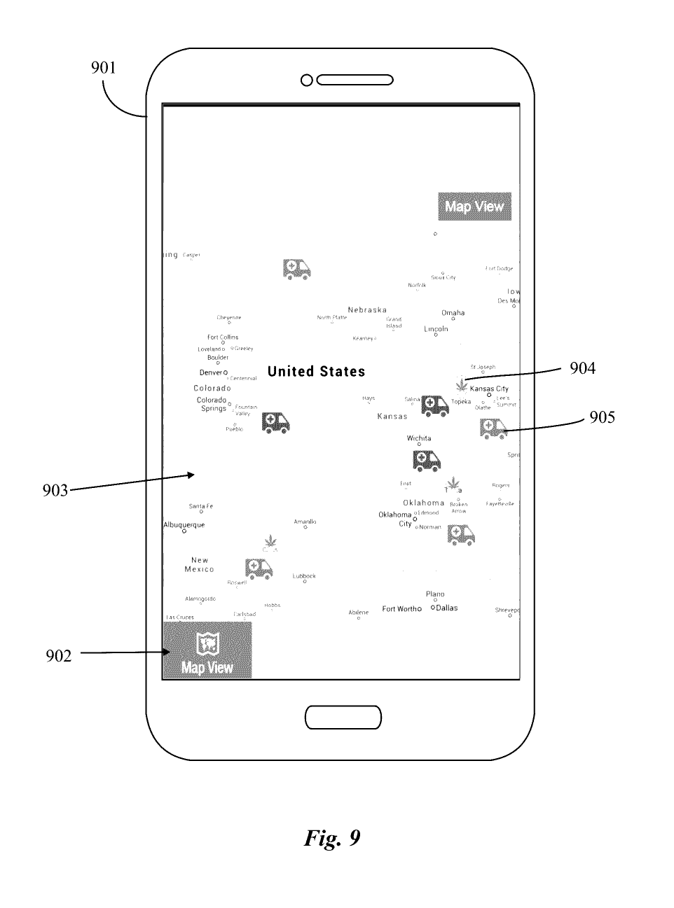

FIGS. 9-16 are screenshots of a user interface illustrating a directory interface according to an embodiment of the present invention. Referring to FIG. 9, the directory interface is shown on a mobile device 901. In this embodiment, a map view selection 902 on a user menu is selected prompting the directory interface to display a map view 903 as illustrated in the exemplary embodiment. The map view comprises an aggregated directory list of dispensaries and doctors which are represented by icons 904/905. The map view includes the list of dispensaries and doctors that are in proximity to the user's location. In some embodiments, the color or shape of the icon may represent or indicate certain options, as well as the type of establishment. In some embodiments, a separate tab may be provided which allows a user to toggle between the list of dispensaries and the list of doctors. If more information about a dispensary or doctor in the aggregated directory list is desired, a user can click on the icon for more information. This will be discussed in greater detail below. The user may utilize zooming function on the map, to set the zoom level of the map as known in the art.

In some embodiments, a user may refine the search, including location and search parameters. For instance, a user may selected a distance radius 10 miles, to limited the directory to only include dispensaries and doctors located within 10 miles of the user's location. In some embodiments, the location radius may be set in 10 mile increments from 10 miles to 50 miles. The search parameters include a plurality of additional search options including but not limited to photos, accessibility, 18+, 21+ specials, system members, payment acceptance type (credit cards/debit cards). For instance, a user may further limit the directory to only include dispensaries and doctors that accept credit cards.

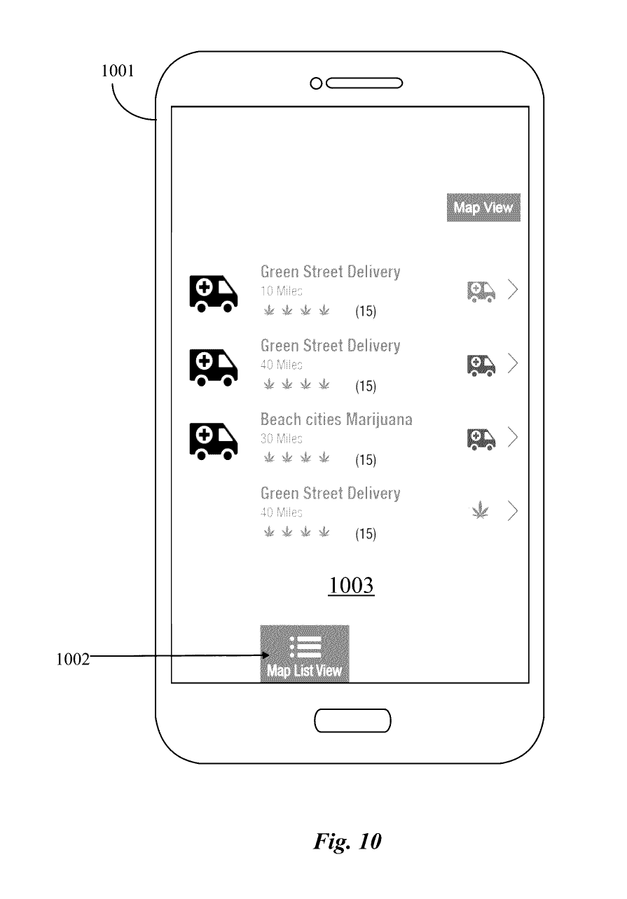

Now referring to FIG. 10, the directory interface is shown on a mobile device 1001. In this embodiment, a list view selection 1002 on the user menu is selected prompting the directory interface to display a list view 1003 as illustrated in the exemplary embodiment. The list view comprises an aggregated directory list of dispensaries and doctors as illustrated. The list view conveniently lists the results comprising a list of dispensaries and doctors that are in proximity to the user's location. If more information about a dispensary or doctor in the aggregated directory list is desired, a user can click on the each listing for more information. This will be discussed in greater detail below.

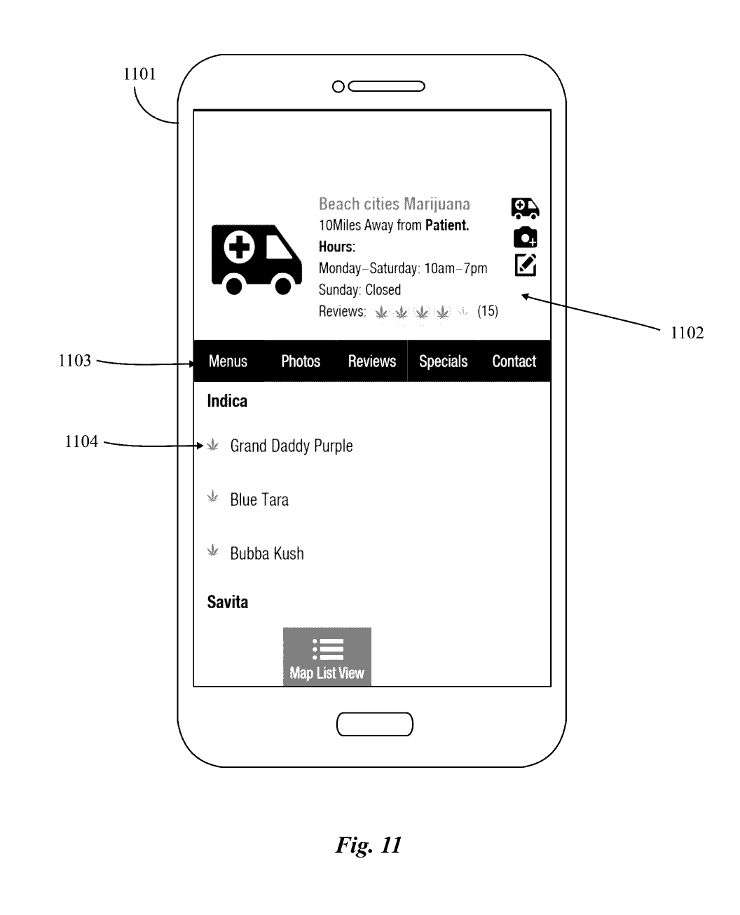

FIG. 11 illustrates the directory interface on a mobile device 1101. The exemplary screen shot is provided after a user selects a specific dispensary. Information 1102 is provided, which includes but is not limited to, dispensary name, distance from the user's location, hours of operation, and rating score based on reviews. The directory interface further includes navigational menu 1103 including menus, photos, reviews, specials, and contact. The contact option allows a user the ability to contact the selected dispensary, as well known in the art. The other menu options will be discussed in greater detail below.

In the exemplary embodiment shown, the menus navigational item is selected prompting menu 1104. The menu comprises a list of medicine provided by the selected dispensary. The list of medicine comprises a plurality of varieties and flavors. In some embodiments, the plurality of varieties is medical cannabis, including but not limited to medical cannabis dried flowers, medical cannabis edibles, and medical cannabis concentrates. In some embodiments, an icon allowing the user to add specific medicine to their favorites is provided. In some embodiment, icons are provided allowing a user to write a review for the selected dispensary, adding the dispensary to favorites, as well as adding the specific dispensary to a digital loyalty card feature, which will be described in greater detail below.

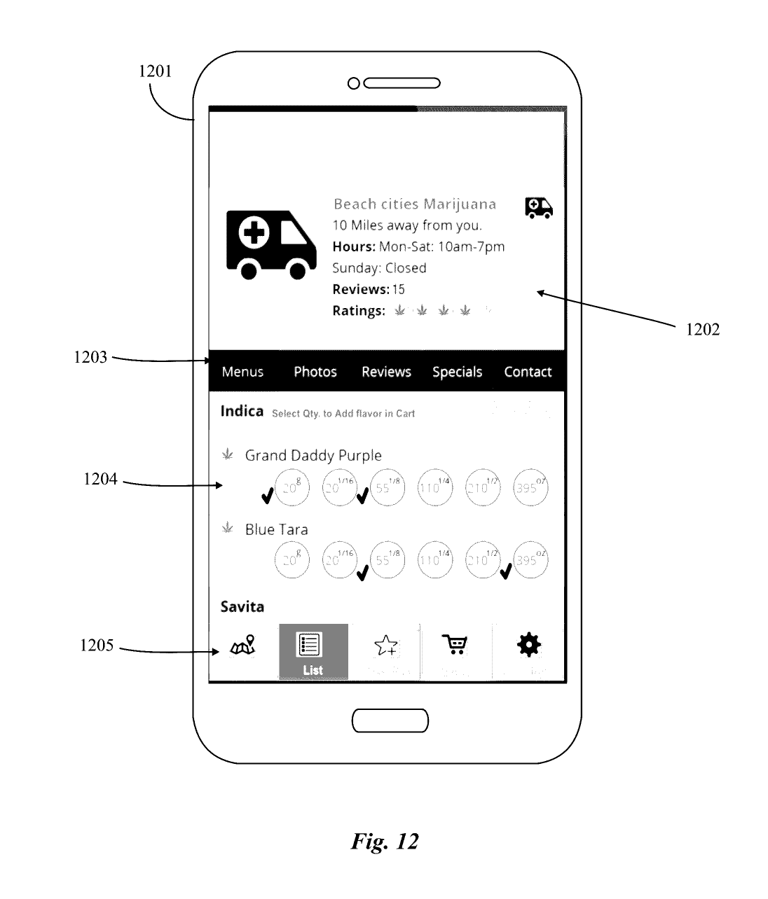

FIG. 12 illustrates an alternative embodiment of a directory interface on a mobile device 1201. The exemplary screen shot is provided after a user selects a specific dispensary. Information 2102 is provided, which includes but is not limited to, dispensary name, distance from the user's location, hours of operation, and rating score based on reviews. The directory interface further includes navigational menu 1203 including menus, photos, reviews, specials, and contact. In the exemplary embodiment shown, the menus navigational item is selected prompting menu 1204. The menu comprises a list of medicine provided by the selected dispensary. The list of medicine comprises a plurality of varieties and flavors. In some embodiments, the plurality of varieties and flavors is medical cannabis, including but not limited to medical cannabis dried flowers, medical cannabis edibles, and medical cannabis concentrates. For each specific medicine, a price is provided for a plurality of measurements. In some embodiments, the pluralities of measurements comprise quantities, including but not limited to, 1/16 oz, ⅛ oz, ¼ oz, ½ oz, and 1 oz. A user may select a specific quantity of a specific variety and flavor and add it to a cart, where it can be purchased and delivered to the user. In some embodiments, an icon allowing the user to add specific medicine to their favorites is provided. An additional navigational menu 1205 comprises shortcuts to a plurality of locations including but not limited to map (FIG. 9), list (FIG. 10), favorites, cart, and settings. Map and list were discussed above, and favorites, cart, and setting will be discussed in further detail below. In some embodiment, icons are provided allowing a user to write a review for the selected dispensary, adding the dispensary to favorites, as well as adding the specific dispensary to a digital loyalty card feature, which will be described in greater detail below.

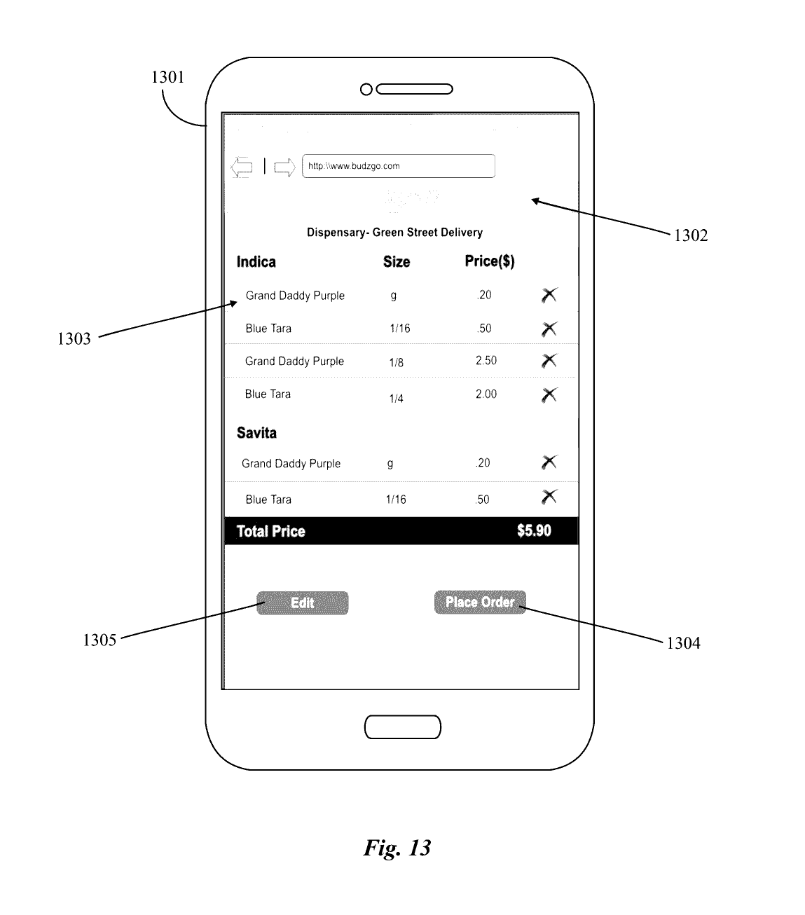

Now referring to FIG. 13, the cart interface 1302 is illustrated on mobile device 1301. The cart comprises a list of medicine 1303 a user has previously added to the cart, as well known in the art. The list of medicine in the cart shows the name and type of medicine, as well as the size/measurement and price. A user may edit 1305 the cart and list of medicine to make changes. Once the user is satisfied with the cart and list of medicine shown, the list of medicine may be purchased by selecting a place order button 1304. After selection, the user proceeds to a payment gateway. The payment gateway includes a card type selection, such as debit or credit by various card providers, as well as queries for credit card numbers, name, expiration date, and card verification value (CVV) as well known in the art.

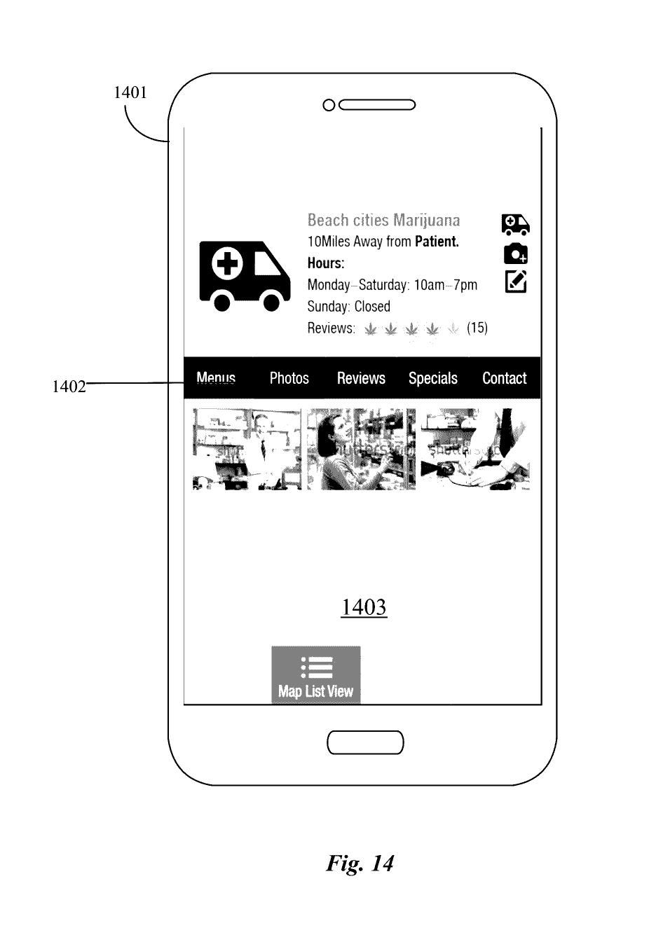

FIG. 14 illustrates the directory interface on a mobile device 1401. The exemplary screen shot is provided after a user selects a specific dispensary. As mentioned previously, information is provided, which includes but is not limited to, dispensary name, distance from the user's location, hours of operation, and rating score based on reviews. The directory interface further includes a navigational menu 1402 including menus, photos, reviews, specials, and contact. In the exemplary embodiment shown, the photos navigational item is selected prompting photos 1403. The photos are photos that the specific dispensary uploads to represent their brand, as well as exemplary photos of their establishment and photos of various menu items.

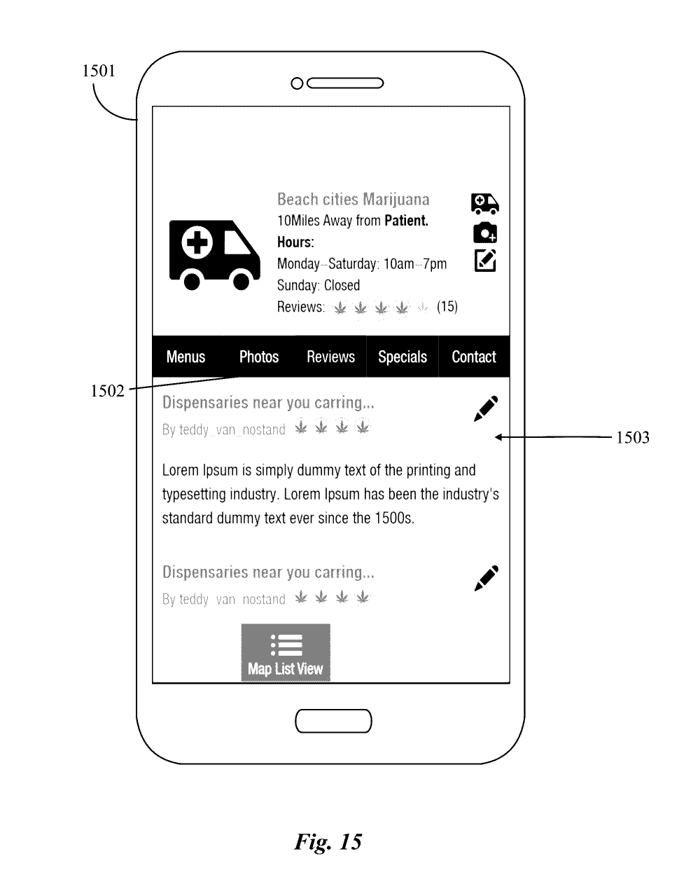

FIG. 15 illustrates the directory interface on a mobile device 1501. The exemplary screen shot is provided after a user selects reviews 1502 from the navigation menu. This selection prompts user reviews 1503 describing a user's experience as well known in the art. Each review includes a rating, on a 0-5 scale, as well as text description describing the review.

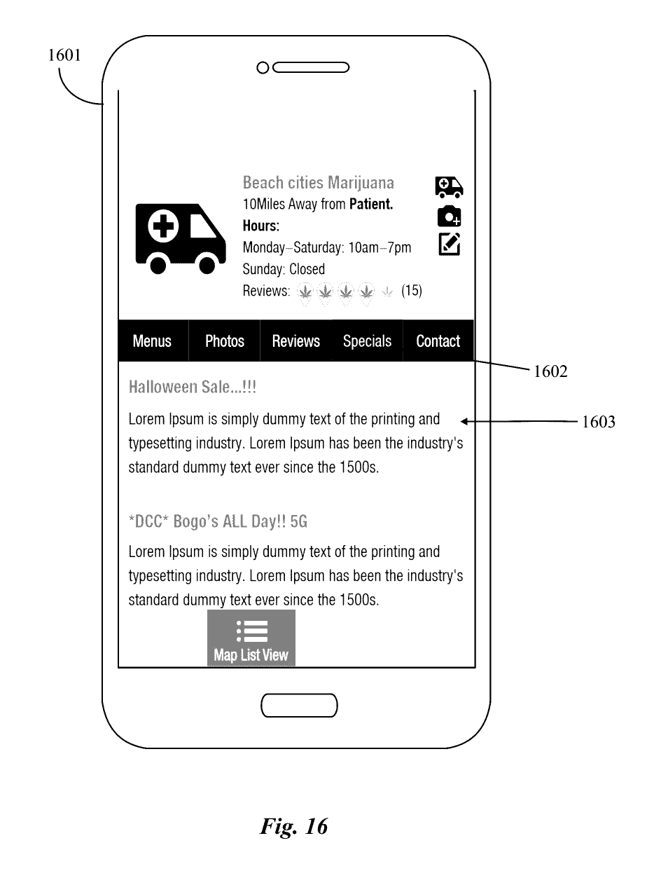

FIG. 16 illustrates the directory interface on a mobile device 1601. The exemplary screen shot is provided after a user selects specials 1602 from the navigation menu. This selection prompts specials 1603 indicating specific promotional specials the dispensary is offering. For instance, a dispensary may offer sales on specific medicine or free medicine for new patients.

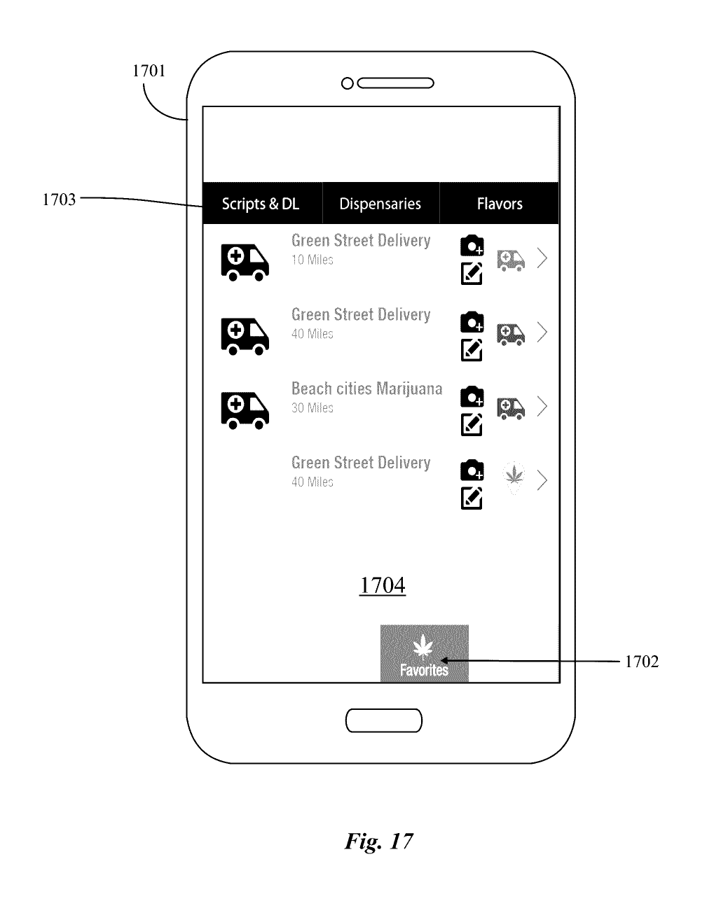

FIG. 17 is a screenshot of a user interface illustrating a plurality of preferences according to an embodiment of the present invention. The plurality of preferences comprises favorites and settings. The exemplary screen shot is provided on mobile device 1701 illustrating an example page from the favorites, which is prompted when favorites icon 1702 on the additional navigational menu is selected. The favorites further comprise scripts & DL (driver's license), dispensaries, flavors, and loyalty card (not illustrated). In the exemplary screen shot provided 1704 dispensaries is selected. This includes a list of dispensaries a user has previously added to favorites. This allows the user to have a consolidated list of previously favorited dispensaries in a convenient location in the system. In some embodiments, the scripts & DL is referred to as ID/Referral and comprises a location where a user can upload a picture of their ID or driver's license, as well as their medical cannabis scripts/referral/recommendation. As described previously, this conveniently allows the user to enter and purchase medicine without having to carry the physical verification documents. The flavors interface allows a user to view specific medicine that was previously favorited. This allows the user to have a consolidated list of previously favorited flavors/medicine in a convenient location in the system.

In some embodiments, settings comprises a plurality of features including but not limited to, a verification link, password management, share, entertainment, contact, privacy policy, terms & conditions, and logout. The verification link allows a user to access the verification process as discussed above. Password management allows the user to change their current password to access the system. Share enables the user to alert other users to try the system on various platforms and social media sites. Entertainment comprises an Internet radio music station and a gaming station. The Internet radio music station plays music as well known in the art, and the specific music is targeted towards users of the system. The gaming station includes games in which users can win prices. Prices may include medicine, such as medical cannabis. In some embodiments, a wheel spinning game is provided, in which a user may spin the wheel for prices once the user's loyalty card is completed. The loyalty card will be discussed in greater detail below.

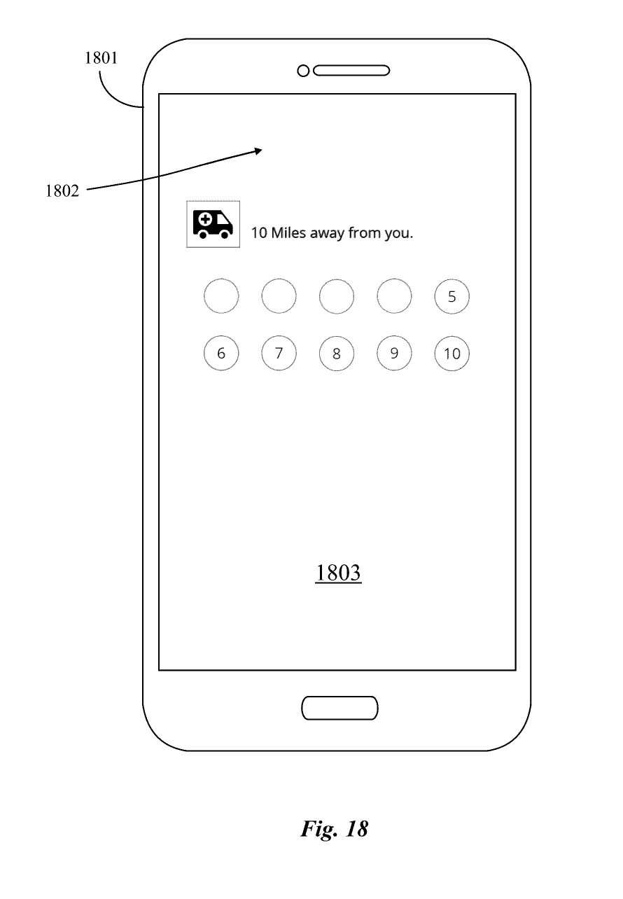

FIG. 18 is a screenshot of a user interface illustrating a marketing reward interface according to an embodiment of the present invention. The marketing reward interface is shown on a mobile device 1801. In this embodiment, the marketing reward interface is a loyalty card 1802 illustrated on exemplary screen shot 1803. As mentioned previously, a user may add a digital loyalty card for selected dispensaries which will keep track of purchases as well known in the art. The specific deal depends on each specific dispensary and their policy. In some embodiments, when the user makes ten purchases they are awarded a free gift or product, which may be a fee quantity of medicine.

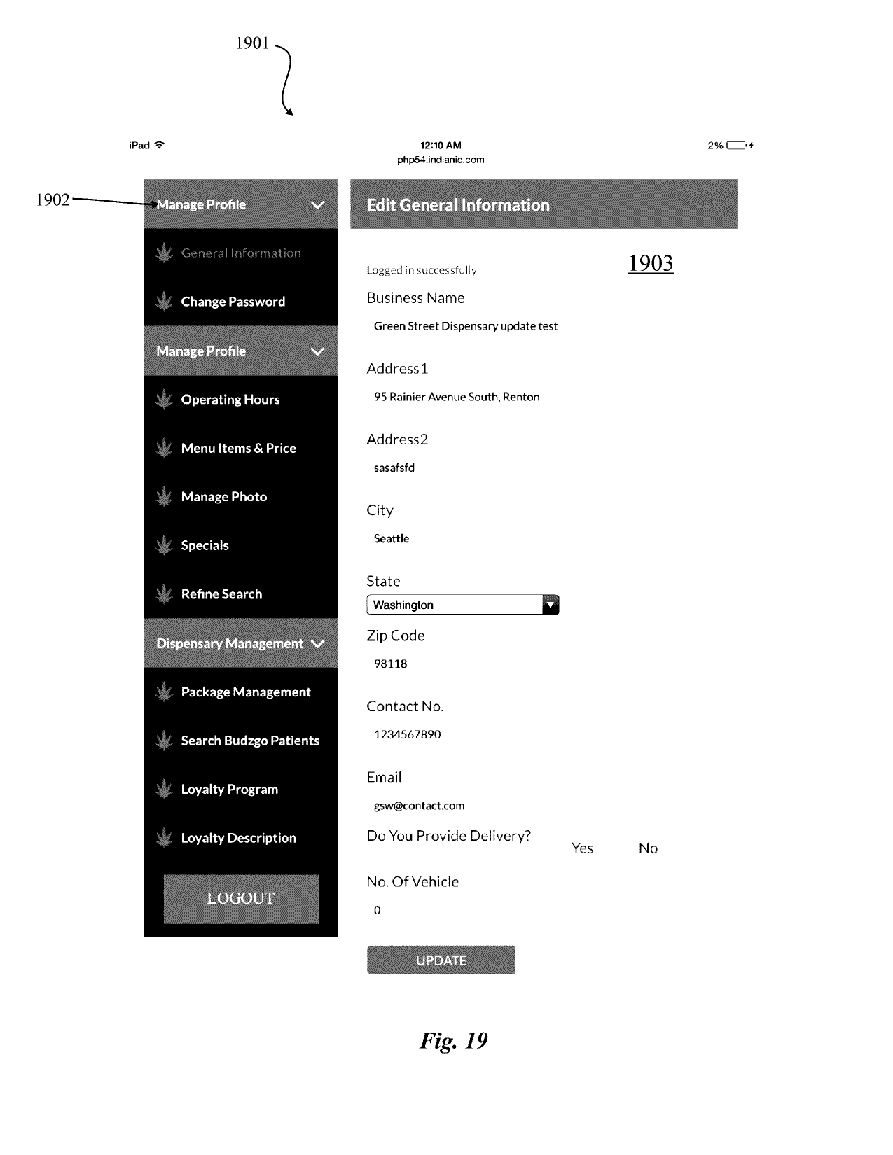

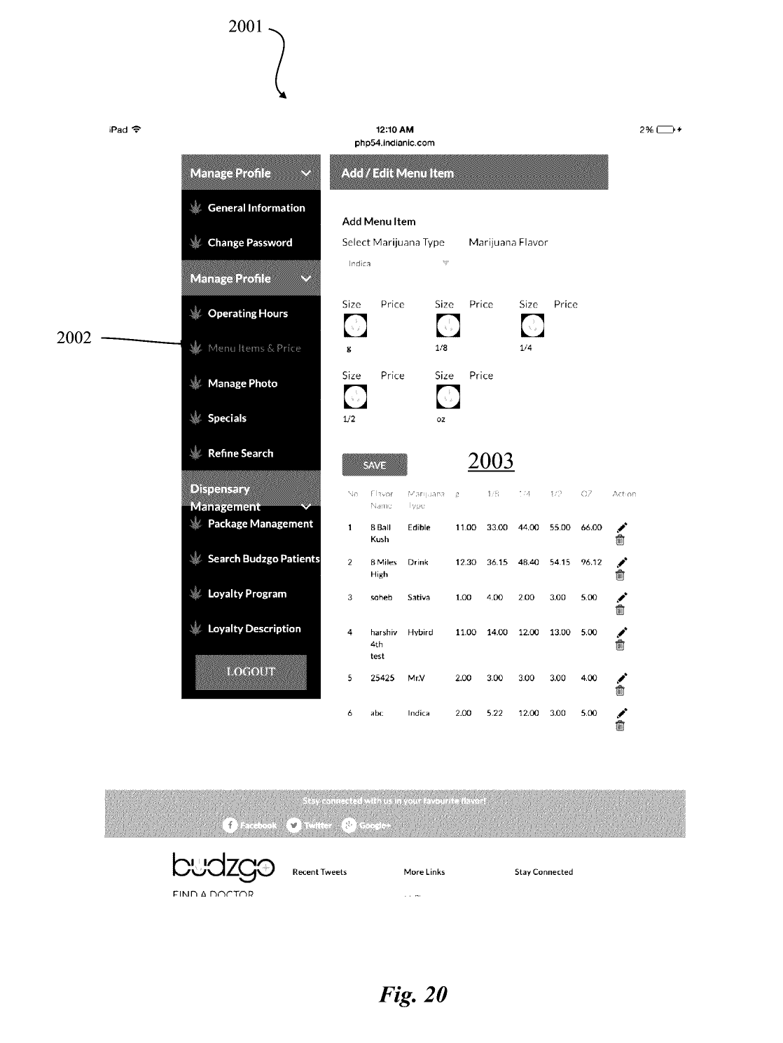

FIGS. 19-20 are screenshots of a user interface illustrating an administrative interface according to an embodiment of the present invention. Referring to FIG. 19, an exemplary screen shot 1901 is illustrated. Specifically, the screen shot illustrates how a dispensary manages their directory listing 1902. For instance, the general information management is selected, enabling a dispensary to add or edit information as illustrated 1903. General information comprises information that appears in the listing as discussed above including but not limited to, business name, address, telephone number, email address, and if the dispensary provides a delivery service. Other management options are provided in the administrative interface including but not limited to change password, operating hours, menu items & price, manage photo, specials, refine search, package management, search patients, loyalty program, and loyalty description. Menu items & price will be illustrated blow. Package management allows a dispensary to purchase specific memberships plans to access the systems. Each membership level offers certain features of the system as well known in the art.

Now referring to FIG. 20, an exemplary screen shot 2001 is illustrated. The screen shot illustrates how a dispensary manages their directory listing and more particularly how the dispensary manages their menu and prices 2002. Illustrated in the exemplary embodiment 2003, a dispensary may add specific medicine to their menu at specific quantities and prices. The menu will appear in the directory listing for the specific dispensary as described above.

In some embodiments, doctors have a similar administrative interface as described above. The administrative interface allows a doctor to manage their listing with information including but not limited to, general information, address, contact information, and fees.

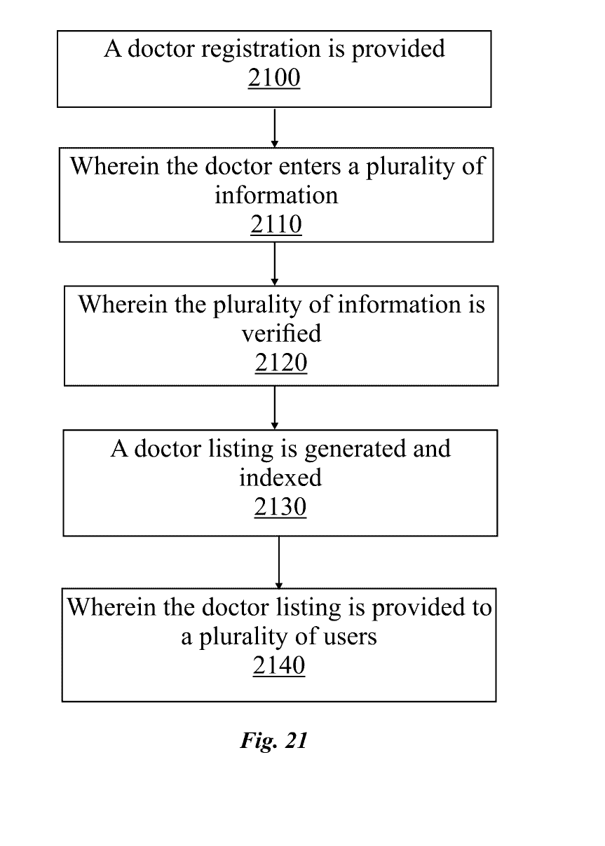

FIG. 21 illustrates a flowchart for a doctor registration process according to an embodiment of the present invention. In step 2100, a doctor registration is provided. In step 2110, the doctor enters a plurality of information. The plurality of information may include business name, doctor name, address, hours of operation, contact, and fees. In step 2120, the plurality of information is verified. Specifically, the doctor and/or business name is verified to determine the legitimacy of the practice. In some embodiments, the plurality of information is not verified until a user files a complaint or contacts the system regarding the specific doctor. Next, in step 2130, a doctor listing is generated and indexed in the system. Finally, in step 2140, the doctor listing is provided to a plurality of users.

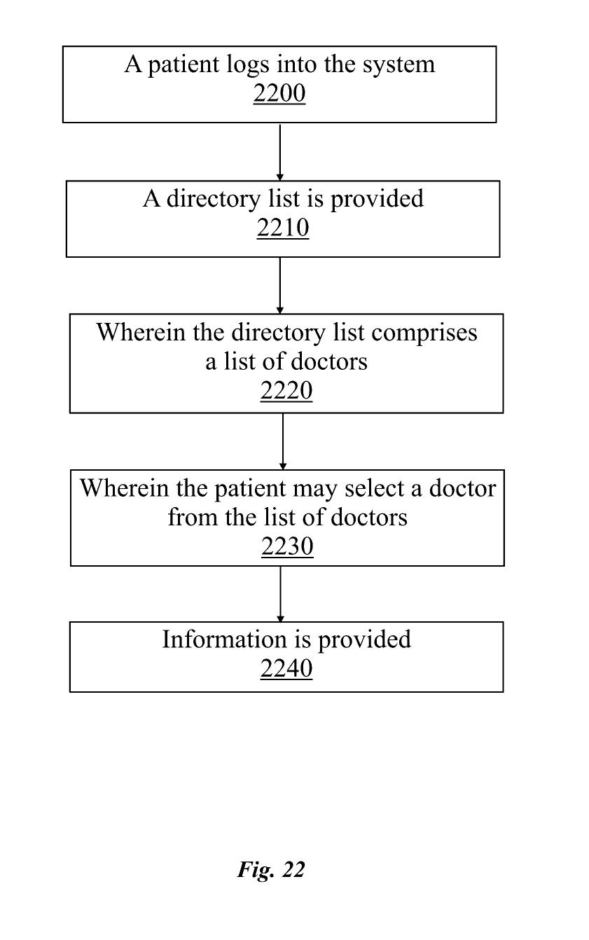

FIG. 22 illustrates a flowchart for an application system according to an embodiment of the present invention. In step 2200, a patient logs into the system. In step 2210, a directory list is provided. In step 2220, the directory list comprises a list of doctors. The list of doctors is in proximity to the patient's location. Next, in step 2230, the patient may select a doctor from the list of doctors. Finally, in step 2240, information is provided. Specifically, the information provided includes doctor name, location, hours of operation, contact, reviews, and fees.

It will be apparent to one with skill in the art, that the embodiments described above are specific examples of a single broader invention which may have greater scope than any of the singular descriptions taught. There may be many alterations made in the descriptions without departing from the spirit and scope of the present invention.

In addition, reference to “first,” “second,” “third,” and etc. members throughout the disclosure (and in particular, claims) are not used to show a serial or numerical limitation but instead are used to distinguish or identify the various members of the group.

What is claimed is:

1. A method comprising steps:
(a) a user at a geographical location using a mobile device logs in to a mobile computer network system;
(b) a first directory list is provided, wherein the first directory list comprises a first list of dispensaries;
(c) a second directory list is provided, wherein the second directory list comprises a first list of doctors;
(d) the user enters a plurality of search preferences, wherein the plurality of search preferences comprises a distance radius and a selection of search parameters;
(e) a third directory list is provided as a result of the plurality of search preferences, wherein the third directory list comprises a second list of dispensaries; and
(f) a fourth directory list is provided as a result of the plurality of search preferences, wherein the fourth directory list comprises a second list of doctors.

2. The method of claim 1, wherein the first, second, third, and fourth directory list is provided on a graphical map.

3. The method of claim 1, wherein a dispensary from the first or second list of dispensaries includes a menu.

4. The method of claim 3, wherein the menu comprises a plurality of medical cannabis at various quantities, varieties, and prices.

5. A method comprising steps:
(a) a medical cannabis patient at a geographical location using a computing device registers to access a computer network system;
(b) a patient verification process is provided, wherein the patient verification process enables the system to verify a physician issued recommendation for the medical cannabis patient;
(c) a first directory list is provided, wherein the first directory list comprises a first list of dispensaries, wherein the first list of dispensaries is located in proximity to the geographical location;
(d) the medical cannabis patient selects a dispensary from the first list of dispensaries; and
(e) a plurality of information is provided, wherein the plurality of information comprises a dispensary name, an address, a listing of operational hours, a rating score, a distance from the geographical location, a menu, a plurality of photos, a plurality of patient reviews, a plurality of sales promotions, and a plurality of contact information; wherein the menu comprises a plurality of medical cannabis.

6. The method of claim 5, further comprising a step wherein the plurality of medical cannabis may be purchased, wherein the purchased medical cannabis is delivered to the medical cannabis patient,

7. The method of claim 5, wherein in step (a), the computing device is a mobile phone.

8. The method of claim 5, wherein in step (b), the patient verification process is performed by a third-party medical cannabis patient verification company.

9. The method of claim 5, wherein in step (c), the first directory list is provided on a graphical map.

10. The method of claim 7, further comprising a step wherein the medical cannabis patient may upload a plurality of verification data to the system, wherein the plurality of verification data comprises a picture of identification and a picture of the physician issued recommendation, wherein the plurality of verification data is stored on the mobile phone.

11. The method of claim 10, further comprising a step wherein the medical cannabis patient may access a brick and mortar dispensary from the first of dispensaries by providing the plurality of verification data.

12. A system comprising:
an Internet-connected computerized appliance having a processor and coupled to a data repository, the processor executing software from a non-transitory medium, the software providing an interactive interface to a mobile application system, the system enabling a medical cannabis patient to:
register an account;
log on;
verify a physician issued recommendation;
set a plurality of search preferences;
access a directory list of dispensaries, each dispensary having a menu of cannabis;
access an address and operational hours to each dispensary;
access a directory list of doctors;
access an address, fees, and operational hours to each doctor;
save each dispensary to favorites;
save cannabis of the menu of cannabis to favorites;
access a digital loyalty card to each dispensary; and
access an entertainment interface.

13. The system of claim 12, wherein the system further enabling the medical cannabis patient to: upload a plurality of verification data to the system, wherein the plurality of verification data comprises a picture of identification and a picture of the physician issued recommendation, wherein the plurality of verification data is stored.

14. The system of claim 12, wherein the cannabis from the menu of cannabis may be purchased, wherein the purchased cannabis is delivered to the medical cannabis patient.

15. The system of claim 12, wherein the entertainment interface comprises an Internet radio station and a gaming station.

16. The method of claim 13, wherein the system further enabling the medical cannabis patient to: access a brick and mortar dispensary from the first list of dispensaries by providing the plurality of verification data.
